(19) United States
(12) Patent Application Publication
(10) Pub. No.: US 2004/0185827 A1
(43) Pub. Date: Sep. 23, 2004

(54) System and method for replenishing an account

(76) Inventor: Michael Parks, Piedmont, CA (US)

Correspondence Address: PATENT DEPARTMENT, SKADDEN, ARPS, SLATE, MEAGHER & FLOM LLP, FOUR TIMES SQUARE, NEW YORK, NY, 10036, US

(21) Appl. No.: 10/759,414

(22) Filed: Jan. 16, 2004

Related U.S. Application Data
(63) Continuation of application No. 10/138,398, filed on May 3, 2002.

(51) Int. Cl. H04M 15/00; H04M 11/00

(52) U.S. Cl. 455/406; 379/114.01

(57) ABSTRACT

A prepaid telephone handset provides a balance retrieval function associated with a soft key. A user selects the soft key on a handset to initiate a balance inquiry for an account associated with the handset. A balance inquiry response message is received by the handset to allow the user to determine available account balance. The soft key allows for a single step retrieval of account balance without initiating a connection to a human operator or an automated system.

### RELATED APPLICATION

This application is a continuation of U.S. patent application Ser. No. 10/138,398, filed May 3, 2002, entitled “SYSTEM AND METHOD FOR REPLENISHING AN ACCOUNT.”

### FIELD OF THE INVENTION

The present invention relates generally to pre-paid telephone service and more particularly to a system and method for replenishing a wireless communication account balance.

### BACKGROUND

Traditionally, telephone service has been paid for after the service was provided. Usually this is done by means of a monthly statement received through the mail and a payment made by check and returned through the mail. Increasingly, the payments are made by automatic debiting from a previously authorized bank account.

From the telephone service provider's viewpoint this process is enormously complicated and expensive. Every call made has to be assessed to determine if it is a billable call, a billing rate has to be determined for the call in accordance with the customer's billing plan which typically specifies different rates as a function of factors such as time of day, day of week, and whether the call is local or long distance, and the duration of the call has to be measured. The bills for the calls made over a period of time such as a month must then be sorted into billing records for all the service provider's customers and these records must be converted into billing statements and distributed to each customer.

From the customer's viewpoint, the process requires attention to the payment of a monthly statement. In the case of customers who do not have checking accounts, this may require the inconvenience of obtaining a money order or the like with which to pay the statement or the inconvenience of paying the statement in person to an agent of the service provider.

In view of all this complexity and expense, there is considerable incentive to develop ways to pre-pay for telephone service and thereby avoid the hassle of after-the-event payment.

Further incentive for pre-paid telephone service arises from the desire to access telephone services from a variety of locations. Such access has been provided by coin-operated telephones. Such service, however, is very expensive, requiring special telephones to collect the payments and secure them until the payments can be retrieved and substantial labor expense to maintain the phones and retrieve the payments made. Collect calls and third party billing arrangements also were developed to provide more flexible access. These services, which were not pre-paid and therefore were subject to all the complexity and expense of other after-the-event billing systems, also incurred additional expenses since they typically required human intervention to place the call.

More recently, pre-paid systems have been developed using various types of pre-paid phone cards.

Prepaid cards look similar to credit cards, but they work like gift certificates for telecommunications service—they may be purchased for selected amounts, allowing the holder of the card to make calls equal in value to the selected amount or for a preselected number of minutes, for example. The front of a pre-paid phone card typically contains some type of graphic image and, perhaps an indication of the price of the card, while either the front or the back of the card includes instructions for use, a telephone number (such as a toll-free 800 number) and, on some types of cards, a personal identification number (PIN) that may be used to make the telephone call. The PIN uniquely identifies an account that is first activated with a credit balance equal to the amount specified on the pre-paid phone card. The PIN can be stored on the card as printed text concealed under an opaque layer that can be scratched off by the purchaser of the card.

To use the card, the holder of the card dials the telephone number printed on the back of the card, and when prompted, dials the PIN and the telephone number to be called. The call thereafter is connected, the account is debited for the time of the call as the call progresses and the caller may receive audible warnings indicating how much call time is left on the card. Generally, the card is not required in order to use an active PIN associated with it. Thus, a person who learns an active PIN could “use” another's card without actually having the card.

Pre-paid phone cards have traditionally been available to consumers at retail establishments, such as in grocery stores, drug stores, gift shops, and the like. Like all goods, phone cards are subject to inventory management.

Some phone cards, called hot cards, are distributed pre-activated to retailers. Such a system is illustrated in FIG. 1. As shown, the system includes a card printer 110, a distribution center 120, a retailer 130, and a telephone service provider 140. Facilities at the telephone service provider include a CPU 150, a PIN generator 155, a PIN database 160, an accounting system 165 and an interactive voice recognition (IVR) unit 170. To prepare the hot cards, as indicated by arrow 180, CPU 150 generates a set of PINs using PIN generator 155 which typically is a software algorithm that runs on the CPU. The PINs are stored in PIN database 160 as indicated by arrow 181. A PIN file is then generated and sent to printer 110 as indicated by arrow 182. This file specifies each PIN and the value of the card on which the PIN is to be printed. The printer 110 then prints the cards, gives each card an inventory tracking number, and as indicated by arrow 183 returns to the service provider a file that identifies the tracking number associated with each PIN. The cards are then shipped to a distribution center 120 as indicated by arrow 184 and then to a retailer 130 as indicated by arrow 185. The PIN is activated by the service provider 140 shortly after the cards are shipped from the distribution center 120. At the time of activation, as indicated by arrow 189A, an account is set up in the accounting system 165 which associates the activated PIN with the value of the card. The retailer 130 then sells a card to a customer 175 as indicated by arrow 186.

To pay for a phone call, the customer 175 scratches off the opaque layer on the card that conceals the PIN and phones the telephone number on the card. As indicated by arrow 187, this connects him to IVR unit 170. IVR unit 170 requests from the customer 175 the PIN and the telephone number being called and, upon receiving them, supplies them to CPU 150 as indicated by arrow 188. CPU 150 forwards this information to accounting system 165 as indicated by arrow 189B and system 165 determines if the PIN is valid and if there is sufficient credit in the account to complete the requested telephone call. If so, the telephone service provider 140 proceeds to complete the connection for the phone call, and, if the connection is made, monitors the call for billing purposes. If the account balance runs low during the course of the call, the service provider 140 will inform the customer of this using tones or a voice message transmitted from the IVR unit 170. Upon completion of the call, the connection to the called party is taken down as is the connection to the customer 175.

Since hot cards always have their indicated value while they are in the retailer's possession, they are kept in inventory like any other physical good. The cards may be sold much like any other product in the store. Unfortunately, relatively small items with relatively high value are frequently the target of shoplifters. Hot cards are especially prone to targeting by shoplifters because they are easily converted to phone call time or cash if sold on the black market.

To combat theft, some retailers use hot card vending machines. Vending machines also have some limitations. For example, vending machines can break down or run out of cards. A retailer may lose revenue while waiting for the machine to be serviced or when the machine is empty.

A retailer has other risks associated with keeping hot card inventory. Since the retailer pays for the hot cards when acquiring them from a distributor, the retailer has a risk of loss if the cards lose value. For example, the provider of the cards could go out of business, rendering the cards worthless and leaving the retailer with useless inventory. Also, the cards could be lost or destroyed by fire or other accident.

A provider or distributor is not free from risk when dealing in hot cards, either. When transporting the hot cards from provider to distributor or from distributor to retailer, there exists a risk of theft of the cards. The cards need not even be stolen to be compromised. If data encoded or written on the cards is acquired, the data may be illegally used to make phone calls as if the card were physically removed from where it belonged.

Retailers who wish to avoid the risks associated with hot cards may choose to work with a prepaid card provider offering pre-paid cards that are activated only when sold. Such cards are known as point-of-sale-activation (POSA) cards.

Such a system is illustrated in FIG. 2. As shown, the system includes a card printer 210, a distribution center 220, a retailer 230, a POSA transaction processor 235 associated with the retailer, and a telephone service provider 240. Facilities at the telephone service provider include a CPU 250, a PIN generator 255, a PIN database 260, an accounting system 265 and an interactive voice recognition (IVR) unit 270. To prepare the cards, as indicated by arrow 280, CPU 250 generates a set of PINs using PIN generator 255 which typically is a software algorithm that runs on the CPU. The PINs are stored in PIN database 260 as indicated by arrow 281. A PIN file is then generated and sent to printer 210 as indicated by arrow 282. This file specifies each PIN and the value of the card on which the PIN is to be printed. The printer then prints the cards, gives each card an inventory tracking number, and as indicated by arrow 283 returns to the service provider a file that identifies the tracking number associated with each PIN. The cards are then shipped to a distribution center as indicated by arrow 284 and then to a retailer as indicated by arrow 285.

At the time the card is sold, the PIN is activated by reading the inventory tracking number on the card. This can be done by entering the number manually into a point-of-sale terminal, swiping the card or scanning it. The number is sent to transaction processor 235 as indicated by arrow 290 and forwarded to CPU 250 as indicated by arrow 291. This constitutes a request to activate the PIN. Upon receiving the request, the service provider determines if the tracking number corresponds to a valid card; and, if so, it sets up in the accounting system as indicated by arrow 289A an account that associates the activated PIN with the value of the card. The retailer then sells the card to a customer 275 as indicated by arrow 286.

To pay for a phone call, the customer scratches off the opaque layer on the card that conceals the PIN and phones the telephone number on the card. As indicated by arrow 287, this connects him to IVR unit 270. IVR unit 270 requests from the customer the PIN and the telephone number being called and, upon receiving them, supplies them to CPU 250 as indicated by arrow 288. CPU 250 forwards this information to accounting system 265 as indicated by arrow 289B and system 265 determines if the PIN is valid and if there is sufficient credit in the account to complete the requested telephone call. If so, the telephone service provider proceeds to complete the connection for the phone call, and, if the connection is made, monitors the call for billing purposes. If the account balance runs low during the course of the call, the service provider will inform the customer of this using tones or a voice message transmitted from the IVR unit. Upon completion of the call, the connection to the called party is taken down as is the connection to the customer.

Advantageously, since the POSA cards hold no value until they are purchased and activated, they can be displayed in high-traffic areas without fear of loss due to theft, resulting in increased card sales.

An alternative system provides for an electronic pin. Such a system is illustrated in FIG. 3. As shown, the system includes a retailer 330, a POSA transaction processor 335 preferably located at or near the retailer, and a telephone service provider 340. Facilities at the telephone service provider include a CPU 350, a PIN generator 355, a PIN database 360, an accounting system 365 and an interactive voice recognition (IVR) unit 370. As indicated by arrow 380, CPU 350 generates a set of PINs using PIN generator 355 which typically is a software algorithm that runs on the CPU. The PINs are stored in PIN database 360 as indicated by arrow 381.

When a customer 375 wishes to purchase a PIN having a selected value, the transaction processor 335 must inform the customer 375 of the PIN number to be used when calling the IVR unit 370 and the service provider 340 must activate an account for that PIN number that has the value associated with the services being purchased. This can be done in a variety of ways. Perhaps simplest and fastest is to generate a set of PINs in advance, mark each such PIN inactive and store it in PIN database 360. When a request is received from the transaction processor 335, as indicated by arrow 391, to issue a new PIN having a stated value, the service provider identifies the next inactive PIN, assigns it the stated value, activates, as indicated by arrow 389A, an account in system 365 identified by that PIN and having the stated value, and provides the PIN to the transaction processor 335 as indicated by arrow 392. The transaction processor 335 then provides the PIN to the retailer as indicated by arrow 393; and, as indicated by arrow 394, the retailer provides the PIN to the customer 375 by, for example, printing it on a receipt for the purchase.

To pay for a phone call, the customer 375 then phones the telephone number on the POSA card, which connects him to IVR unit 370, as indicated by arrow 387. IVR unit 370 requests the PIN and telephone numbers being called from the customer 375 and, upon receiving them, supplies them to CPU 350 as indicated by arrow 388. CPU 350 forwards this information to system 365, as indicated by arrow 389B, which determines if the PIN is an activated PIN and if there is sufficient credit in the account to complete a telephone call. If so, service provider 340 proceeds to complete the connection for the phone call and, if the connection is made, monitors the call for billing purposes. If the account balance runs low during the course of the call, the service provider 340 will inform the customer of this using tones or a voice message transmitted from the IVR unit 370. Upon completion of the call, the connection to the called party is taken down as is the connection to the customer 375.

The PIN and other electronic data requires time to generate and transmit. To reduce the transaction time for a customer, PINs and other electronic data are normally generated in advance of a transaction that results in the purchase of a PIN. In that way, the transaction time is reduced to some degree although the transaction normally will still require notification of a remote system of the sale of a PIN so that the PIN can be activated.

While the sale of POSA cards and electronic PINs is more time-consuming than that of hot cards, some POSA programs enable the printing of information onto a card about 3 seconds after a clerk initiates a PIN activation request and receives approval from the POSA system. Delays due to transmission speed or transmission problems directly degrade the efficiency of POSA sales transactions. So, while POSA programs may reduce the risk of loss, they require increased sales transaction time.

A local distribution center (LDC) terminal located at a retailer can be used to reduce sales transaction time at the point of sale. In systems using such a terminal, the electronic PIN is active for at least a short time prior to the sale. The LDC terminal may improve transaction speed by pre-approving PINs at low-traffic times, such as very early in the morning. However, this requires that the LDC terminal maintain a database of active PINs. Accordingly, LDC terminals that maintain an active PIN database are less secure than cards that are truly activated at the point of sale. Also, LDC terminals entail additional inventory complexity since each terminal contains unique active electronic stocks.

Some so-called LDC terminals located at a retailer do not maintain a database of active PINs. Rather, these terminals access an LDC. If the LDC is located nearby, the transaction time may be reduced, though not by as much as it would be reduced if the terminal itself was an LDC. Also, transmission of the active PINs may result in additional security concerns and increase network traffic at inconvenient times, such as when network traffic is high.

A disadvantage of typical prior art systems in utilizing these PINs is that the customer is unable to replenish an account. The customer has to purchase another PIN. And those systems that allow replenishment of an account through the use of a PIN typically do not also allow replenishment by way of a credit or debit card or direct payment from a checking account. These problems are especially acute for wireless communication users (for example, mobile phone users) who may be nowhere near a retailer at the time it becomes necessary to obtain a PIN to replenish the account. What is needed, therefore, is a system that allows replenishment of a telephone account using either a PIN or a credit or debit card or a direct payment and using any of a plurality of access methods for replenishing the account.

### SUMMARY OF THE INVENTION

The present invention is a method of replenishing a pre-paid telephone account using a PIN or a credit/debit card or a checking account and any one of a variety of access methods including a handset display, an interactive voice recognition unit, or the Internet. For any of these access methods and payment methods, the present invention determines an account to be replenished, determines the amount to be replenished, determines that finds are available to replenish the account, executes the replenishment, and confirms replenishment to a user.

In the case where a handset is used to effect replenishment, the present invention can accomplish replenishment with a single keystroke. The present invention further provides for retrieving a balance in a single keystroke.

In one embodiment, the invention provides a method for obtaining an account balance of a wireless communication account, the wireless communication account associated with an account identifier. The method associates a handset identifier with the wireless communication account. The method transmits a first message to an account maintenance system in response to a user selection of a predetermined handset key, where the first message includes at least the handset identifier and the account identifier. Finally, a handset associated with the handset identifier obtains the account balance by receiving a second message, which provides an account balance for the wireless communication account associated with the account identifier.

### BRIEF DESCRIPTION OF THE DRAWINGS

Additional objects and features of the invention will be more readily apparent from the following detailed description and appended claims when taken in conjunction with the drawings, in which:

FIG. 1 illustrates a prior art hot card distribution and validation system;

FIG. 2 illustrates a prior art point-of-sale-activation (POSA) card distribution and validation system;

FIG. 3 illustrates a prior art POSA electronic personal identification number (e-PIN) distribution and validation system;

FIG. 4 is a block diagram illustrating a handset for use in an embodiment of the present invention;

FIG. 5 is a block diagram illustrating an account maintenance system in accordance with an embodiment of the present invention;

FIGS. 6A and 6B are a flow chart of a transaction for credit/debit card replenishment of an account using a handset in accordance with an embodiment of the present invention;

FIGS. 6C and 6D depict illustrative display screens used in implementing the method of FIGS. 6A and 6B;

FIG. 6E depicts illustrative display screens used in implementing the method of FIG. 10;

FIGS. 7A and 7B are a flow chart of an interactive voice recognition (IVR) transaction for replenishment of an account using a credit/debit card in accordance with an embodiment of the present invention;

FIGS. 8A and 8B are a flow chart of a web-based Internet transaction for replenishment of an account using a credit/debit card in accordance with an embodiment of the present invention;

FIGS. 9A and 9B are a flow chart of a transaction for replenishment of an account through a human agent using a credit/debit card in accordance with an embodiment of the present invention;

FIG. 10 is a flow chart of a transaction for purchased personal identification number (PIN) replenishment of an account using a handset in accordance with an embodiment of the present invention;

FIG. 11 is a flow chart of an IVR transaction for replenishment of an account using a purchased PIN in accordance with an embodiment of the present invention;

FIG. 12 is a flow chart of a web-based Internet transaction for replenishment of an account using a purchased PIN in accordance with an embodiment of the present invention;

FIG. 13 is a flow chart of a transaction for replenishment of an account through a human agent using a purchased PIN in accordance with an embodiment of the present invention; and

FIGS. 14A-14B are flow charts of a preferred method for enabling one-key replenishment of an account using a handset.

Like reference numerals refer to the same element throughout the several views of the drawings.

### DETAILED DESCRIPTION OF THE INVENTION

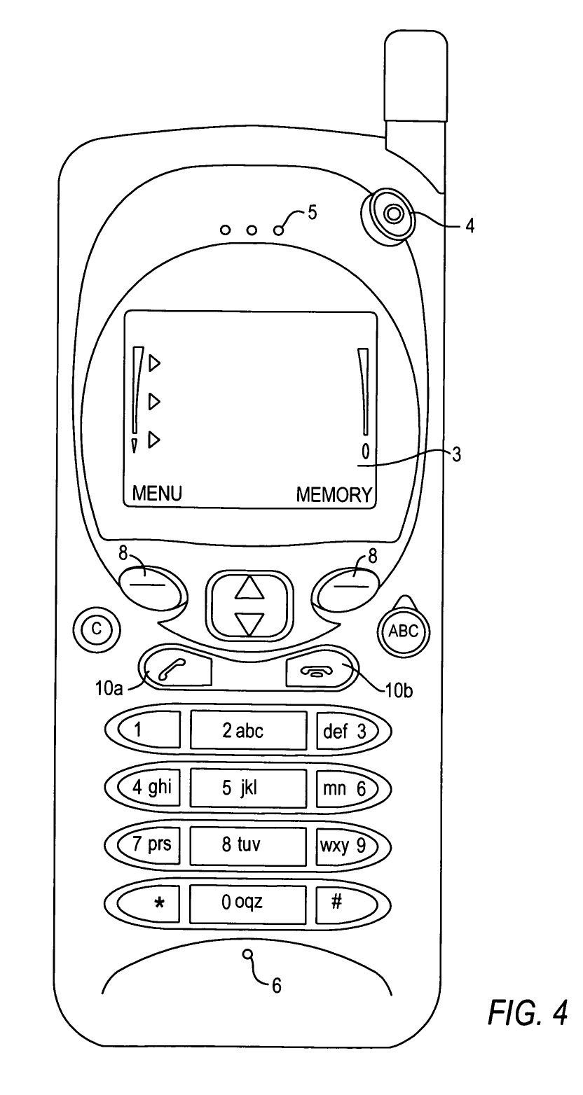

FIG. 4 shows a handset 1 for use in an embodiment of the invention. The handset 1 comprises a user interface having a display 3, an on/off button 4, an earpiece 5, a microphone 6 and a keypad 7. Keypad 7 has a first group of keys in the form of alphanumerical keys, by means of which the user can enter a telephone number, write a text message (SMS), write a name (associated with the telephone number), etc. The user uses the first group of keys primarily for entering data in the telephone (enter events). The first group of keys includes a ‘*’ key and a ‘#’ key that preferably are soft keys.

The keypad additionally comprises a second group of keys which, in this embodiment, comprises operation keys 8 or soft keys whose function depends on the present state of the telephone. The default function or the present function of the operation keys 8 is displayed in a predetermined area of the display 3. The second group of keys additionally comprises a scroll key 9 by means of which the user can scroll selectively from one item to the preceding or the succeeding item in the menu loop of the telephone, while he gets access to a submenu loop under the item concerned in the main menu loop by activation of an operation key. The keypad additionally has a send key 10a and an end key 10b, which respectively may be used for initiating and ending a call.

The arrangement of the user interface shown in FIG. 4 is only illustrative. For example, moving user interface features from the front face of the handset to another face or faces enables the phone to be reduced in size, particularly in length. Moreover, it often results in an ergonomically improved handset. For example, keys placed on the rear of the handset assist single handed operation, enable more accurate operation as they are actuated using a finger instead of a thumb, and are more accessible when the user is in a call. Also, the user's view of the display is not hindered by the presence of a thumb across the front of the phone when selecting menu options, for example. Various types of user interface input means positioned off of the front face of the handset are exemplified in the accompanying drawings.

The handset 1 may be used for any prior art voice or data communication, including voice, SMS, email access, and web browsing.

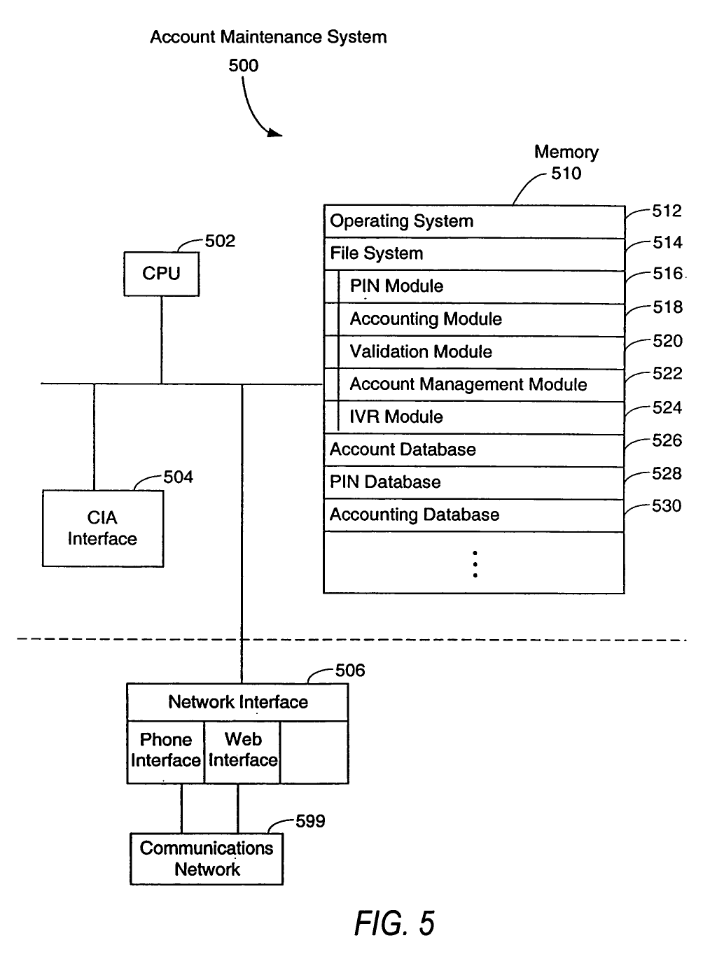

FIG. 5 illustrates an account maintenance system 500 typically operated by a telephone service provider in accordance with an embodiment of the present invention. Account maintenance system 500 comprises a CPU 502, a central intelligence agent (CIA) 504, a network interface 506, which includes a phone interface and a web interface, and a memory 510. The CIA is a human agent, perhaps operating in a service bureau, who is available to answer a customer's phone call and provide or initiate the services the customer requests. The memory 510 contains an operating system 512, a file system 514, an account database 526, a personal identification number (PIN) database 528, and an accounting database 530. The file system 514 contains a PIN module 516, an accounting module 518, a validation module 520, an account management module 522, and an interactive voice recognition (IVR) module. The account database 526 includes entries for each account, including mobile identification number (MIN) status, access code, account balance, thru date, secret question, and secret answer fields. Possible status entries includes, for example: current, past current, suspended, expired, or voluntary disconnect. The network interface 506 is coupled with a. communications network 599. The memory 510 is controlled by CPU 502.

The accounting module 518 records transaction details in the accounting database 530. The accounting module 518 may store data in the accounting database 530 for valid or invalid transactions. The accounting module 518 may also store data regarding account database 526 changes.

The overall operation of an account involves maintaining payment information for customers. Customers must have an appropriate status, as recorded in a status field stored in the account database 526, to perform certain functions, such as make a phone call. Other fields, such as the thru date field establish an expiration date for the account after which the account becomes inactive. This date is typically set to be several months after the last activity charged to the account. The use of such a field allows the account maintenance system to remove inactive accounts from its active files.

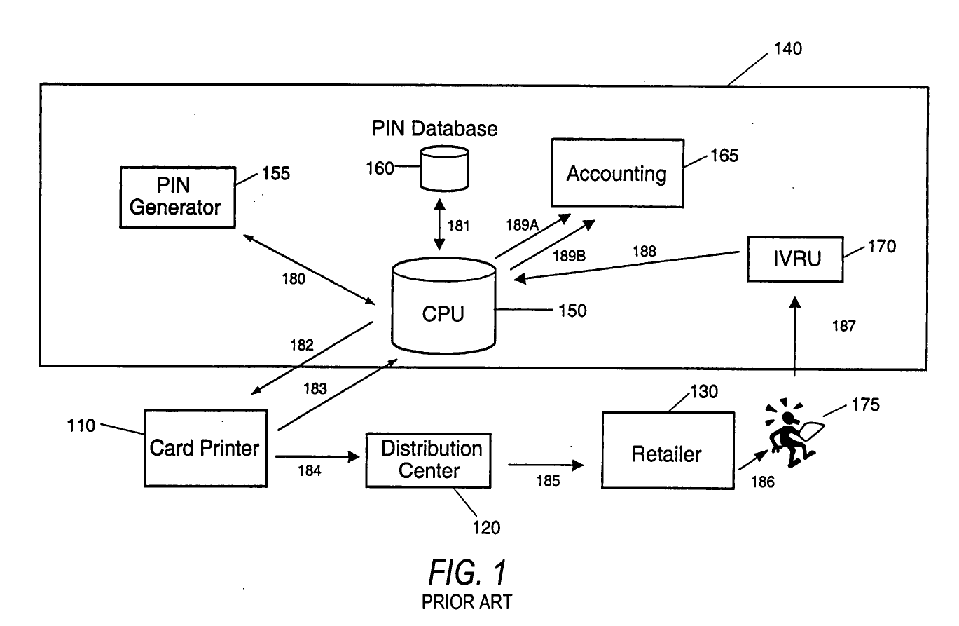

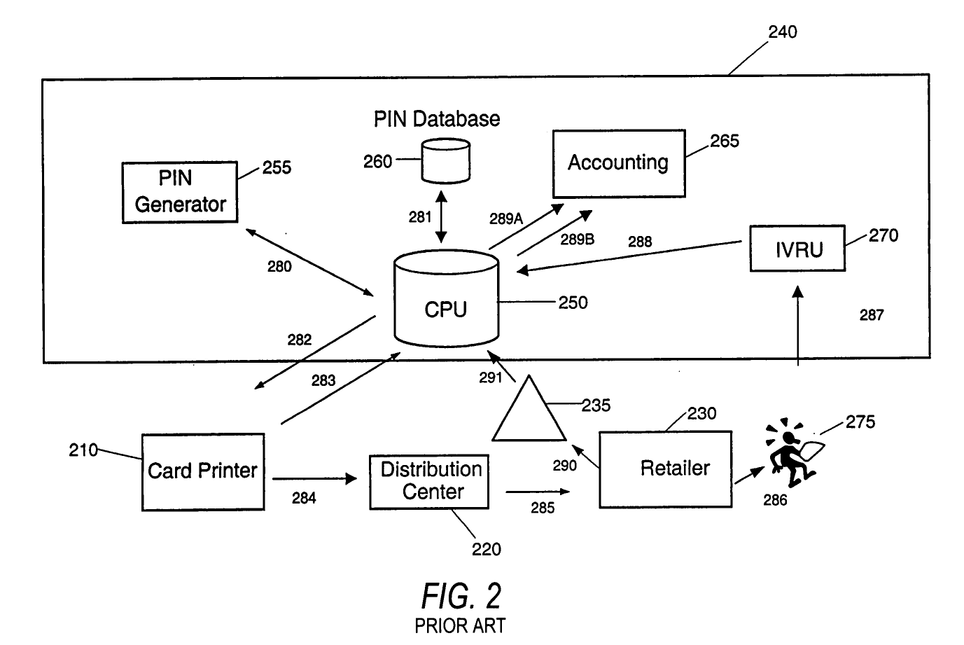

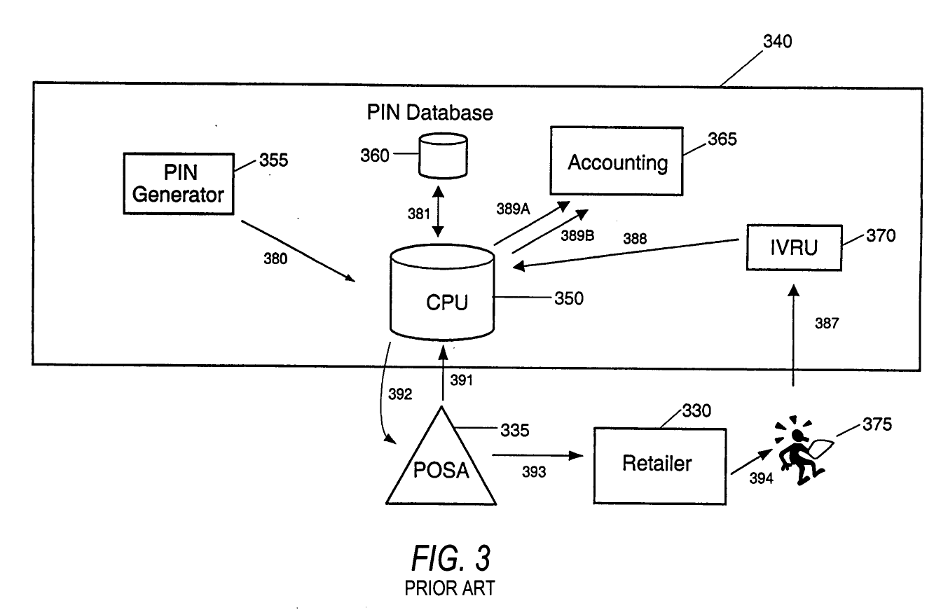

The handset and account maintenance system of FIGS. 4 and 5 are used to facilitate the pre-payment of telephone services and, in particular, the replenishment (or topup) of a pre-paid account associated with a customer. In accordance with the present invention, a variety of different payment methods may be used to replenish a pre-paid account including, without limitation, credit or debit card payments, direct payment from a checking account, and purchase and use of a PIN. As suggested by the description of FIG. 5, access to the account maintenance system may be made by telephone interface, web interface or through a human agent. Illustratively, the telephone interface provides both an interface with the display 3 of the handset of FIG. 1 and a voice interface in the form of an IVR unit.

Although there are many variations, for each of the payment methods and each of the access methods, the account maintenance system 500 generally performs the following steps to replenish an account:

determination of the account to be replenished;

determination of the amount to be replenished;

determination that the funds are available to replenish the account;

execution of the replenishment function and updating of records; and

confirmation that the account has been replenished.

Determination of the account to be replenished entails capturing an account identifier. Each account identifier is associated with an account that includes a replenishable balance. Since each mobile handset has a unique mobile identification number (MIN), the MIN is preferred as an account identifier. Preferably, each MIN will also have at least one access code associated with it, for example a validation key (vKey). A customer should generally keep his access codes secret to prevent others from accessing his account without his authorization. The vKey often functions as a password to provide additional security for customers whose mobile phone, for example, is taken or stolen or whose MIN becomes known by someone else.

When a customer attempts to replenish an account, but is unable to provide a preferred account identifier, an invalid account identifier exception, for example, an “unable to access MIN exception,” occurs. An invalid account identifier exception may occur because, for example, the account identifier does not exist in the database or is in an inactive state. In one embodiment, if the account is in an inactive state, the customer, or an agent acting on behalf of the customer, is given the option to reactivate deactivated accounts and then resume a replenishment transaction. Optionally, after an invalid account identifier occurs the customer or an agent may provide some other unique account identifier, such as by answering a secret question. Generally, multiple attempts at identifying an account are allowed. However, if the number of attempts exceeds a maximum number, such as three, an exception may occur. The system may provide some guidance to the customer, such as by suggesting the customer contact customer service.

In some cases, such as when a customer is already logged into an account, the system may have already captured some information, such as a MIN. In these cases, the system will generally skip over the steps that prompt the user to enter the information again.

By entering an account identifier that is not the customer's, the customer may be granted limited access to an account. In this way, a third party may replenish an account. Thus, even if the system has already captured an account identifier, such as a MIN, associated with the customer's account, the customer may enter a different MIN as a third party.

Once the account identifier is captured and the account is identified, the system generally attempts to capture a replenishment. amount. Some accounts or payment types may have a pre-determined replenishment amount. To help prevent fraud, the system preferably validates the replenishment amount with one or more tests. In one test, for the replenishment amount to be acceptable, it must not exceed a pre-set maximum replenishment for a single transaction. In another test, a maximum amount for a given period, for example a daily maximum amount, must not be exceeded. In another test, the dollar amount added, regardless of the amount, cannot result in the account balance exceeding the maximum threshold.

When the system determines that the amount is valid, the system then attempts to determine whether funds are available to replenish the account. The method of making this determination is typically dependent upon what type of payment method is used. Generally, the customer must provide (or have provided previously) payment information. For example, credit/debit card information may include card number, expiration date, and billing name and address. Note that use of the term “credit/debit card” means that a customer may use either a credit card or a debit card or perhaps even both (though not in a single replenishment transaction). For a registered credit/debit card, an access code may be required in order to retrieve credit/debit card information. For a non-registered credit card, an account identifier, such as a MIN, may be sufficient.

In general, a successful determination entails an authorization of payment. Otherwise, an unauthorized payment exception, such as an invalid credit card exception, may occur. An invalid credit card exception occurs, for example, when the card holder's billing address does not match the address of record, the card holder's billing address is not valid (e.g., city-zip code mismatch), the card is marked lost/stolen, the credit card authorization service is down, the credit/debit card has insufficient finds, the credit/debit card number is not valid, or the expiration date is not valid (e.g., bad format or outdated). An unauthorized payment exception generally entails informing the customer that the transaction cannot continue and instructing the customer on how to proceed. Different action may be taken if the unauthorized payment may be fraudulent (e.g., a customer attempting to use a credit card that was reported lost/stolen). In some cases, for example, if payment is not authorized, but no fraud is apparent, the customer may be directed to reenter payment information. Generally, the customer may resubmit payment information a pre-determined number of times, such as three, before an unauthorized payment exception occurs. In that case, a customer may be instructed to contact customer care or, if using a card, to contact the card issuer.

When a customer attempts to use a pre-registered payment method, an access code is generally required. An invalid access code validation may occur when, for example, the access code entered is not the correct access code for the selected credit/debit card or when no access code is entered. In one alternative, the account holder has the option of selecting from different cards registered to the account; and the system has the ability to associate the appropriate access code to the associated credit/debit card. Provision may also be made for third party replenishment. Preferably, in the case of an invalid access code exception, the customer should be directed to customer care.

Execution of the replenishment function and updating of records follows authorization of payment. A balance associated with the account to be replenished is increased by the replenishment amount. Other records, such as the thru date, are modified in conformity with account information provided and established procedures, such as that of providing a time stamp for the transaction. In an alternative, the replenishment amount is a payment amount less a service charge.

In one embodiment, the system is designed to encourage customers to register a credit card by awarding bonus airtime when a newly registered credit card is used to replenish an account. In accordance with this embodiment, a customer first registers a credit card. Some time following the registration of the card, when the card is used to replenish the customer's account, the system increases the account balance by a predetermined bonus amount. Preferably, a customer is awarded this bonus only one time (i.e., the first time a registered card is used to replenish an account).

The system also provides confirmation that the account has been replenished. This confirmation typically takes the form of an SMS message to the handset associated with the account. In addition to or instead of the SMS message, the system could provide confirmation to a third party that replenished the account. Note that the owner of the associated handset may be treated as a “third party” in some instances if account information is provided to the system through some input method other than the handset input method, such as via a web-based application. In general, a third party will receive confirmation in the form of an account identifier and, for example, the total amount replenished, rather than more detailed information, such as a new account balance or thru date.

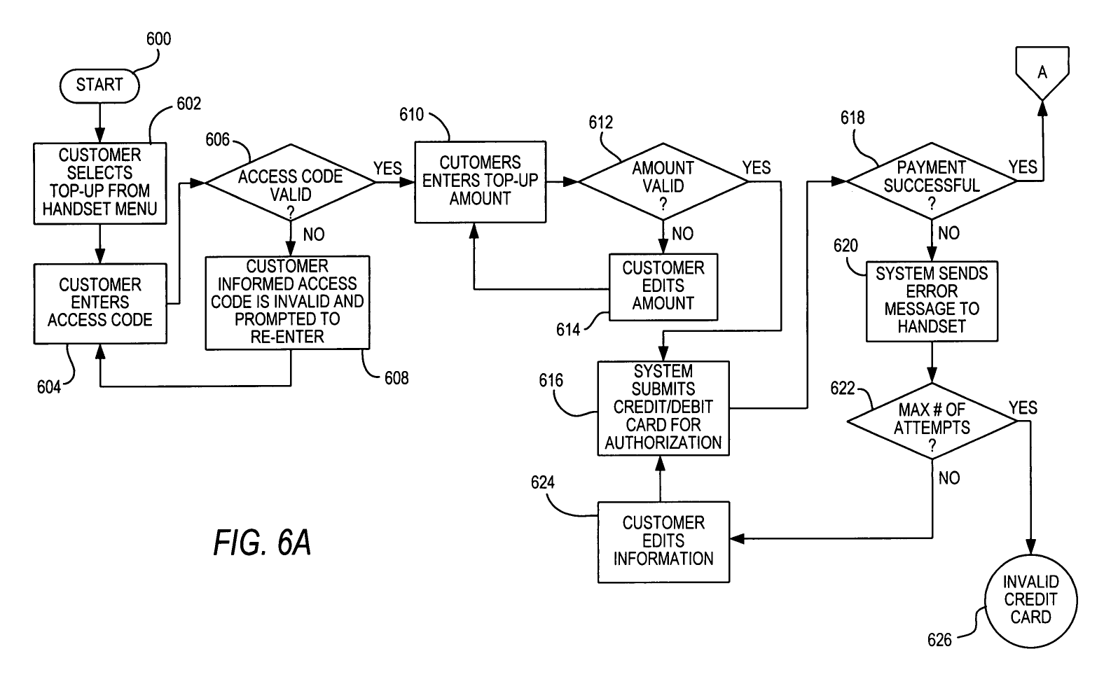

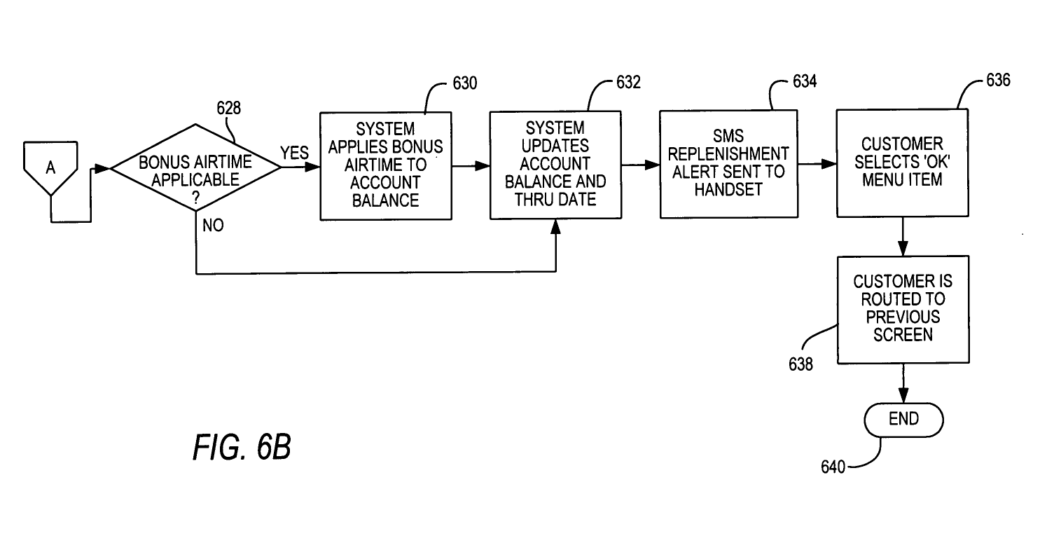

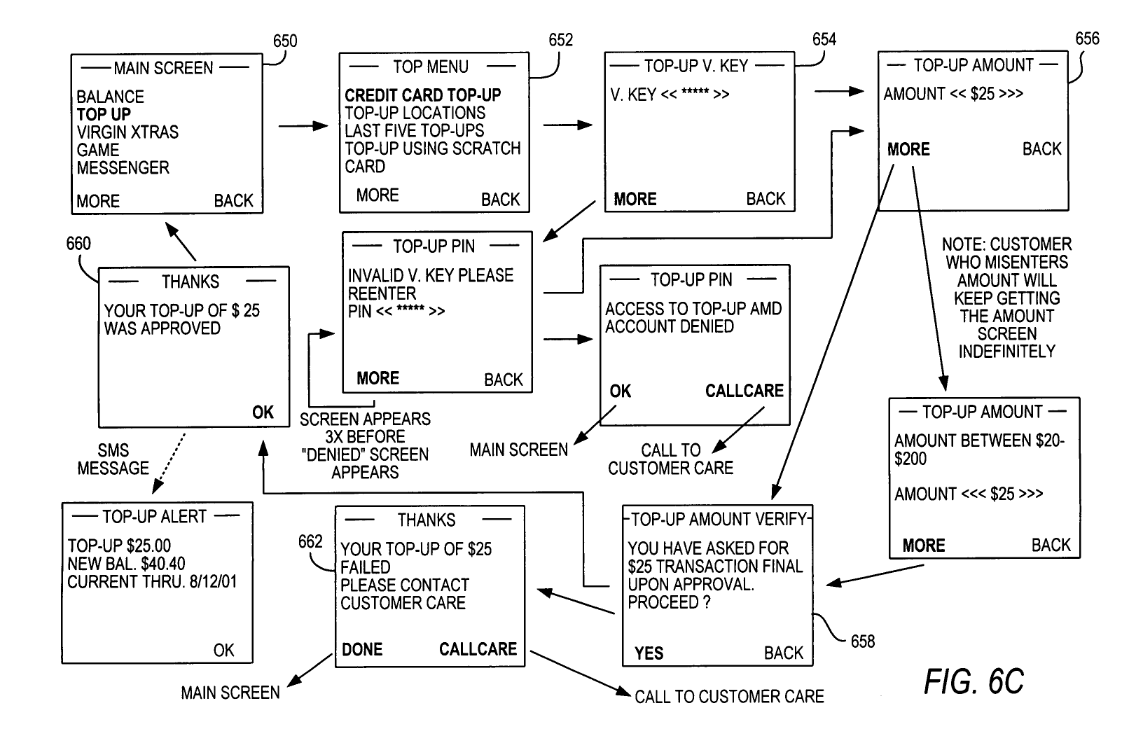

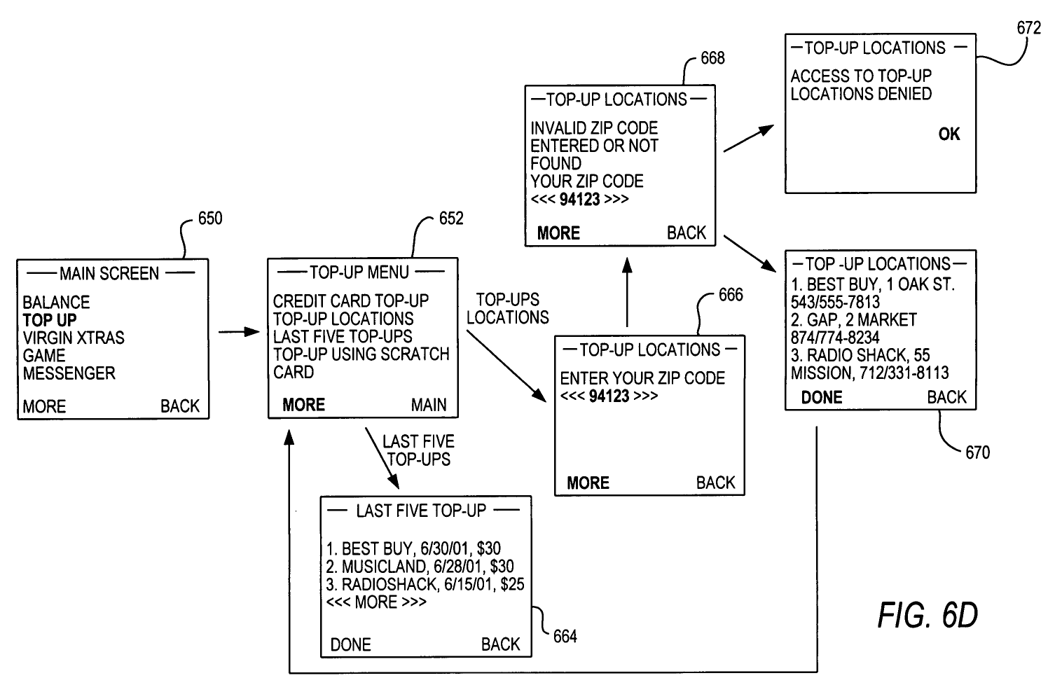

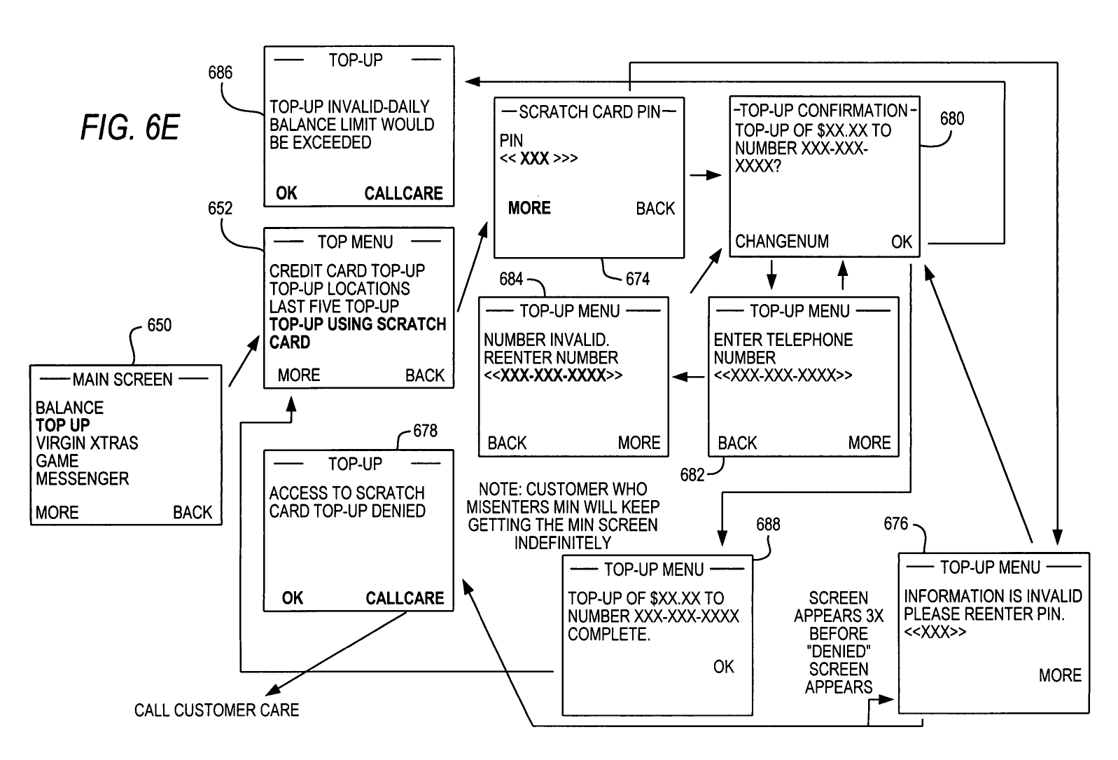

FIGS. 6-13 detail how these steps are performed in the case of payments by credit card or debit card and by PIN and the four access methods of handset display, IVR unit, web access, and human agent. It is assumed that an account has previously been set up in the account maintenance system and that it is identified by at least one of a variety of indicia including a MIN that uniquely identifies the customer's handset.

FIGS. 6A and 6B are a flow chart of a credit/debit card replenishment of an account using a handset in accordance with an embodiment of the present invention. The transaction starts at 602 when the customer selects top up from the handset menu. The handset menu could be displayed, for example, in a display 3 of a handset 1 (FIG. 4). Illustrative menus are described below in the discussion of FIGS. 6C-6E. The customer then enters an access code at 604. The access code is tested at 606. If the access code is not valid, the customer is informed at 608 that the access code is invalid and is prompted to reenter the access code.

When the access code is determined to be valid, the customer enters the amount he desires to add to his account (the replenishment amount) at 610. This amount may be tested at 12 in a variety of ways, as described previously. If the amount is not acceptable, the customer edits the amount at 614 and/or reenters the top up amount. When the amount is acceptable, the system submits a previously registered credit/debit card for authorization and payment at 618. If payment is not authorized, the system sends an error message to the appropriate handset at 620. If the system fails to obtain authorization after a specified number of times, an invalid credit card exception, described previously, occurs at 626. If no exception has occurred, but the system has not yet attempted payment a maximum number of times, the customer may edit the information at 624, and the system resubmits the credit/debit card for authorization. Also, if appropriate, following an invalid credit card exception, the customer may be prompted to reenter payment information at 610. If payment is approved, the credit/debit card account is charged the account to be added to the customer's account and this amount less any service fee is added to the customer's account. Next, the system tests at 628 if a bonus is to be awarded. If so, the system applies bonus airtime to the account balance at 630. The system updates the account balance and thru date at 632. An SMS replenishment alert is sent to the appropriate handset at 634. The customer can acknowledge the SMS message by selecting ‘OK’ from the menu at 636. The customer is then routed to a previous screen at 638 and the transaction ends at 640.

A particularly useful feature of the present invention enables the replenishment function to be effected as a result of a single keystroke by a handset user. This is accomplished by programming one of the soft keys so that activation of that key causes the account maintenance system to perform the remaining steps of the process illustrated in FIGS. 6A and 6B so as to add a pre-arranged amount to the customer's account. This feature is particularly useful when the customer is advised in the course of a phone call that his account is running low. In accordance with the invention, he can respond to such a warning simply by clicking the appropriate soft key and funds will be added to his account.

Since the keypad has only a limited number of keys and only a few soft keys that must be used for many functions, this operation of the soft key is limited to situations where the customer can use it best. One such situation described above is where the customer is already engaged in a phone call. This situation has the added advantage that the customer has already identified himself to the account maintenance system in the course of placing a call or his handset's MIN has been identified in the course of receiving the call. These are sufficient to identify the customer's account and there is no need for further entry of an access code as in step 604 of FIG. 6A. Once the customer has initiated the replenishment process in this way, the remaining steps set forth in FIGS. 6A and 6B can be performed by the account maintenance system without further intervention by the customer provided a replenishment amount is agreed on in advance.

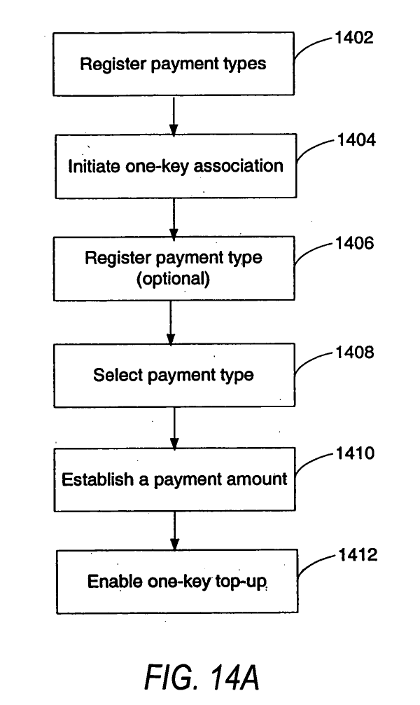

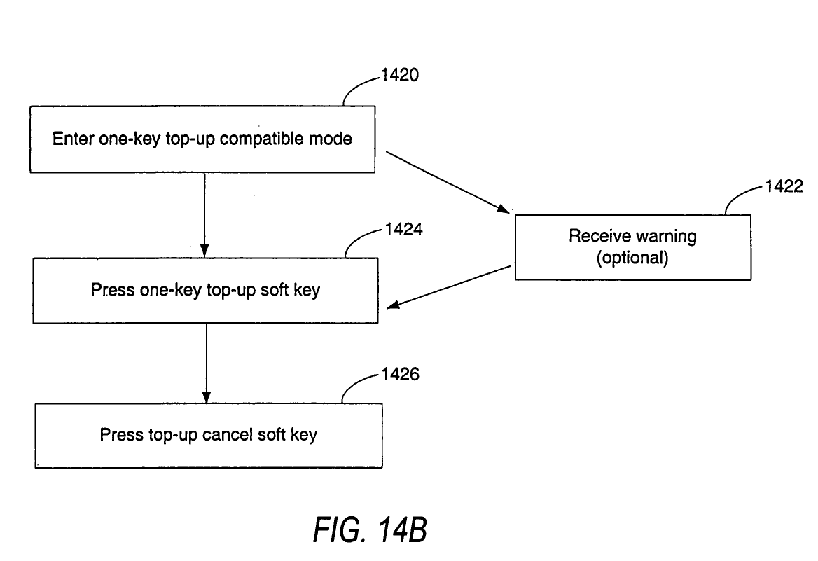

FIG. 14A is a flow chart of a preferred method for enabling one-key replenishment. In this embodiment, a payment type is preferably registered at 1402. This pre-registration may involve registration of multiple payment types such as credit card or direct payment from a checking account. When a customer initiates a one-key replenishment soft key association at 1404, the customer may elect which of the keys (such as from keys 8 of FIG. 4) to associate. In an alternate embodiment, the system may assign a key, such as the ‘*’ key, as the one-key replenishment soft key without customer input. When a customer selects a payment type at 1406, the payment type is preferably one of the registered types. Optionally, the system may allow registration of another payment type at 1406. The customer selects any of the registered payment types at 1408 and establishes a payment amount at 1410. Preferably the system tests the payment amount as described previously. However, some tests, such as a test to ensure that the maximum periodic replenishment amount is not exceeded, must be executed when the replenishment is actually requested. Finally, the customer may enable at 1412 a soft key with the registered payment type and the payment amount, such as by selecting “OK” from a list of mean options.

FIG. 14B is a flow chart of a preferred method for utilizing an enabled one-key replenishment soft key. Since the function of soft keys is dependent upon the mode of operation, a customer with an enabled one-key replenishment soft key must enter a one-key replenishment compatible mode at 1420 prior to initiating a one-key replenishment. Preferably, one such mode is while the customer is making a phone call. Thus, if the customer receives a warning at 1422 that his account balance is too low, the customer may conveniently press a single key at 1424 to replenish his account. The customer need not wait for a warning to perform a one-key replenishment and may press the one-key replenishment soft key prior to the account balance reaching a level that causes the system to generate a warning message. Preferably, the customer can cancel a replenishment at 1426 by pressing a pre-determined key sequence within a pre-determined period of time following a one-key replenishment. This allows the customer to change his mind or, if the soft key was pressed accidentally, avoid an undesired replenishment.

Advantageously, the one-key replenishment may also be practiced in other circumstances where the customer has already identified himself to the account maintenance system. For example, some customers may find it convenient to replenish their account as they are about to begin their phone call. Since the ‘*’ key is not ordinarily used in the course of a phone call, one embodiment of the invention activates this key to initiate a one-key replenishment whenever a customer's account is identified to the account maintenance system. In another embodiment, entering a predetermined key sequence, for example “99”, within a predetermined period of time after pressing the one-key replenishment soft key cancels the top up.

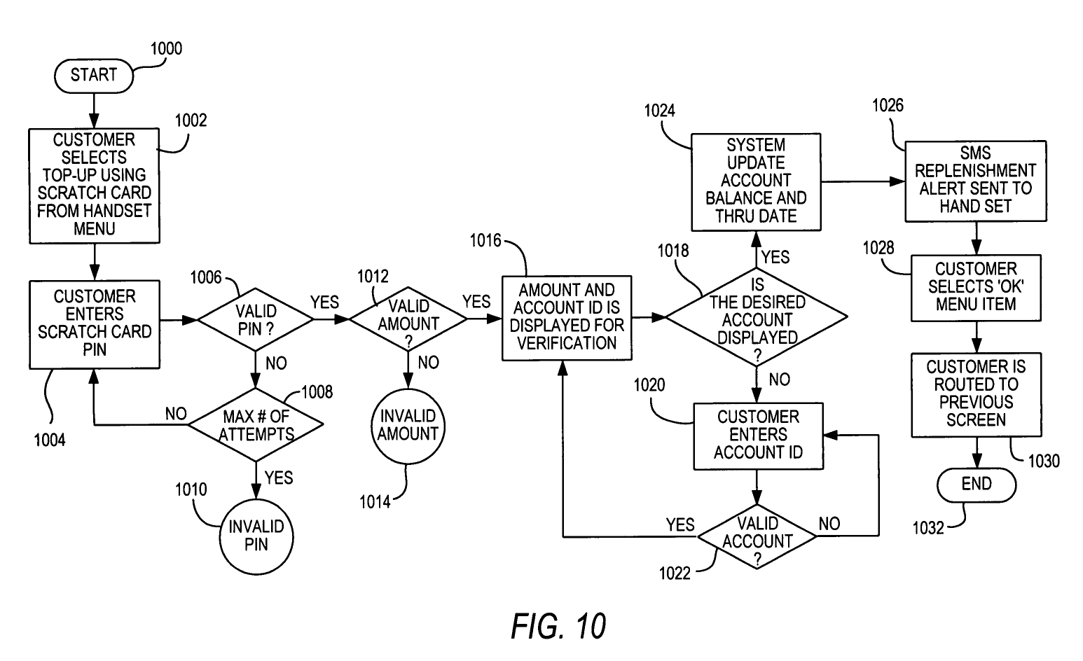

FIGS. 6C and 6D depict illustrative display screens used in implementing the method of FIGS. 6A and 6B. Main screen 650 provides a selection of activities including replenishment. Upon selecting “top-up”, top-up menu 652 is presented. Upon selecting credit card top-up, top-up vKey screen 654 is presented. The vKey screen is a request that the customer enter the access code (or validation key). Alternatively, the customer could also elect to replenish his account using a scratch card or purchased PIN. This alternative is discussed in FIG. 10. Top-up amount screen 656 is presented when an account identifier is provided. The top-up amount verify screen 658 is presented once the top-up amount is accepted. The thanks screens 660 and 662 respectively indicate that the replenishment was approved or that the replenishment was not approved. If approved, ‘OK’ may be selected and the main screen 650 is presented. An SMS message may also be sent that the replenishment was approved. If not approved, the customer may either return to the main screen 650 or contact customer care.

If, at top-up menu screen 652, last five top-ups is selected, the last five top-ups screen 664 is presented.

If, at top-up menu screen 652, top-up locations is selected, top-up locations screen 666 is presented and a zip code may be entered. The top-up locations screen 668 may be presented if the zip code is not valid and the top-up locations screen 670 may be presented when a valid zip code is entered. Multiple invalid zip code entries may result in the presentation of top-up locations screen 672, indicating access is denied.

Screens 674 through 688 are discussed below in conjunction with FIG. 10.

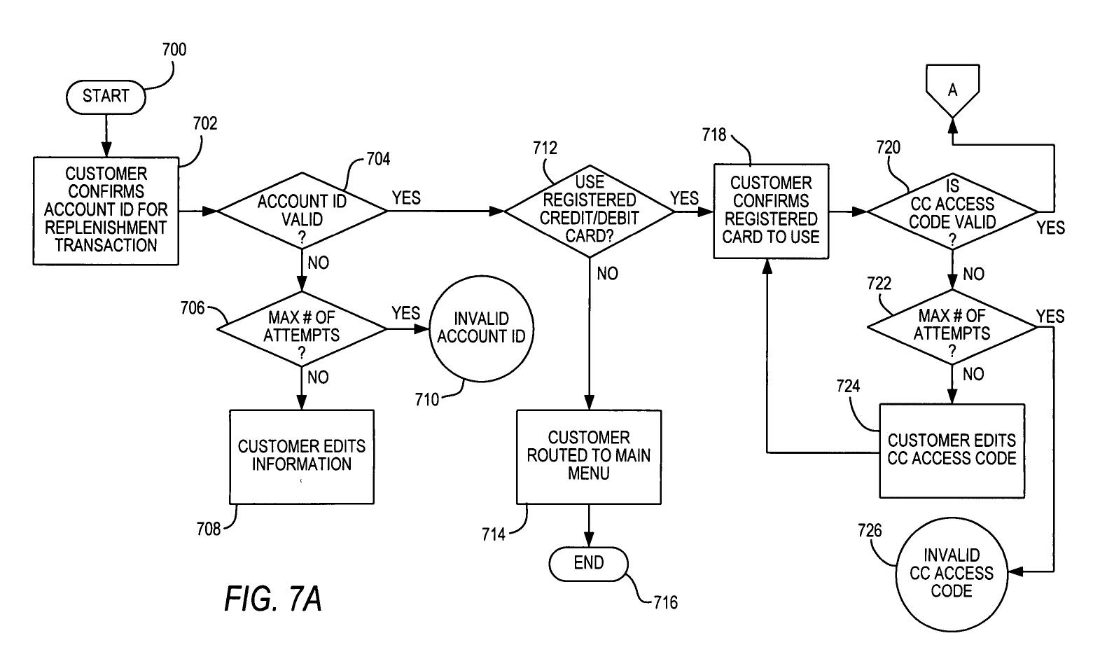

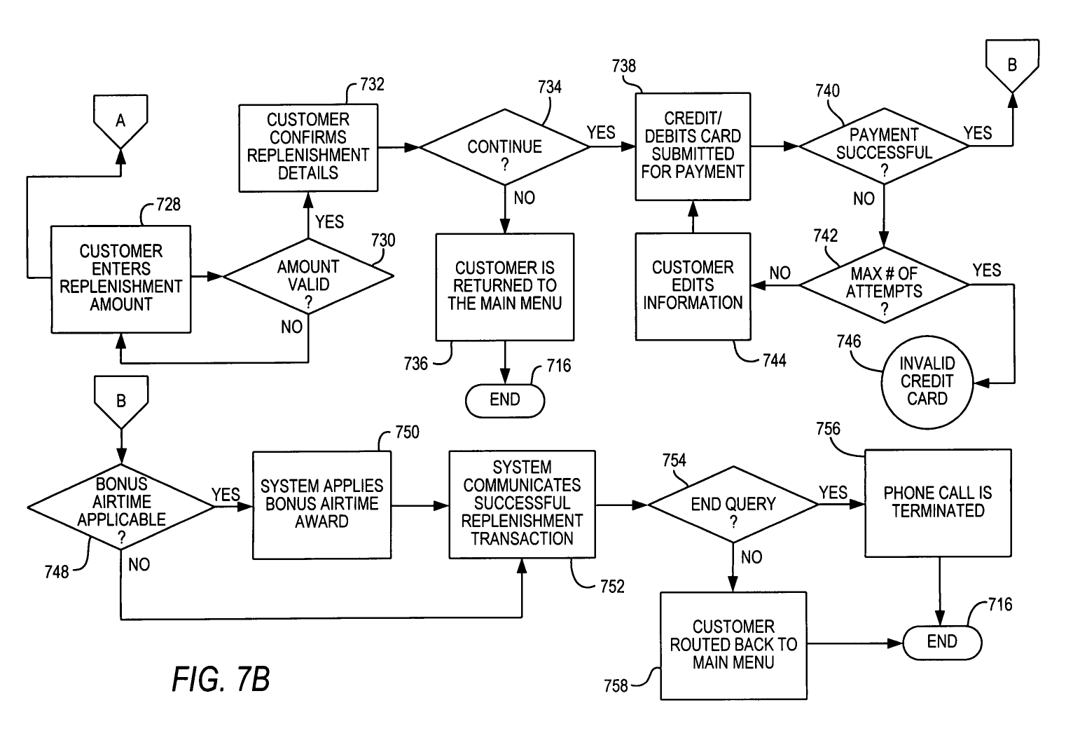

FIGS. 7A and 7B are a flow chart of an IVR transaction for replenishment of an account using a credit/debit card in accordance with an embodiment of the present invention. The transaction starts at 702 when the customer supplies the account ID for a replenishment transaction. Note that account information, including the account ID, may have been captured previously by the system, in which case the customer may simply confirm the account ID. However, if the customer is not calling from his handset, or has not previously logged in, the account ID may not be captured initially. In this case, the IVR system will prompt the customer to enter an account ID. In any case, the account ID is tested at 704. If the account ID is not valid or if the customer wishes to enter a different account ID than the one captured, the customer may edit the information at 708 and resubmit it. If the account ID is still invalid after a maximum number of attempts, an invalid account ID exception occurs at 710.

When the account is successfully identified, the customer may choose at 712 not to use a previously registered credit/debit card, in which case the customer is routed to the main menu at 714 and the transaction ends at 716. Alternatively, the customer may choose to use a registered credit/debit card and confirm the registered card to use at 718. An access code for use of the credit card is tested at 720. If the credit card access code is not valid, the customer may edit the access code at 724 and resubmit it. If the access code remains invalid for more than the maximum number of allowed attempts, an invalid access code exception occurs at 726.

If the access code is valid, the customer enters a replenishment amount at 728. This amount may be tested at 730 in a variety of ways as previously described. When a valid replenishment amount is entered, the customer confirms the replenishment details at 732. If the customer chooses not to continue, the customer is returned to the main menu at 736 and the transaction ends at 716. If the customer wishes to continue, the credit/debit card is submitted for authorization and payment at 738. Assuming an invalid credit card exception, as described previously, does not occur, the credit/debit card account is charged the amount to be added to the customer's account and this amount less any service fee is added to the customer's account. Next, the system may, as described previously, award bonus airtime at 750.

The system then communicates the successful replenishment transaction at 752. The customer may choose to continue at 754, in which case the customer is routed back to the main menu at 758 and the transaction ends at 716, or the customer may choose to end the phone call at 754, in which case the phone call is terminated at 756 and the transaction ends at 716. In an alternative, the customer has two options for ending the call, hanging up or pressing or saying a number to hang up.

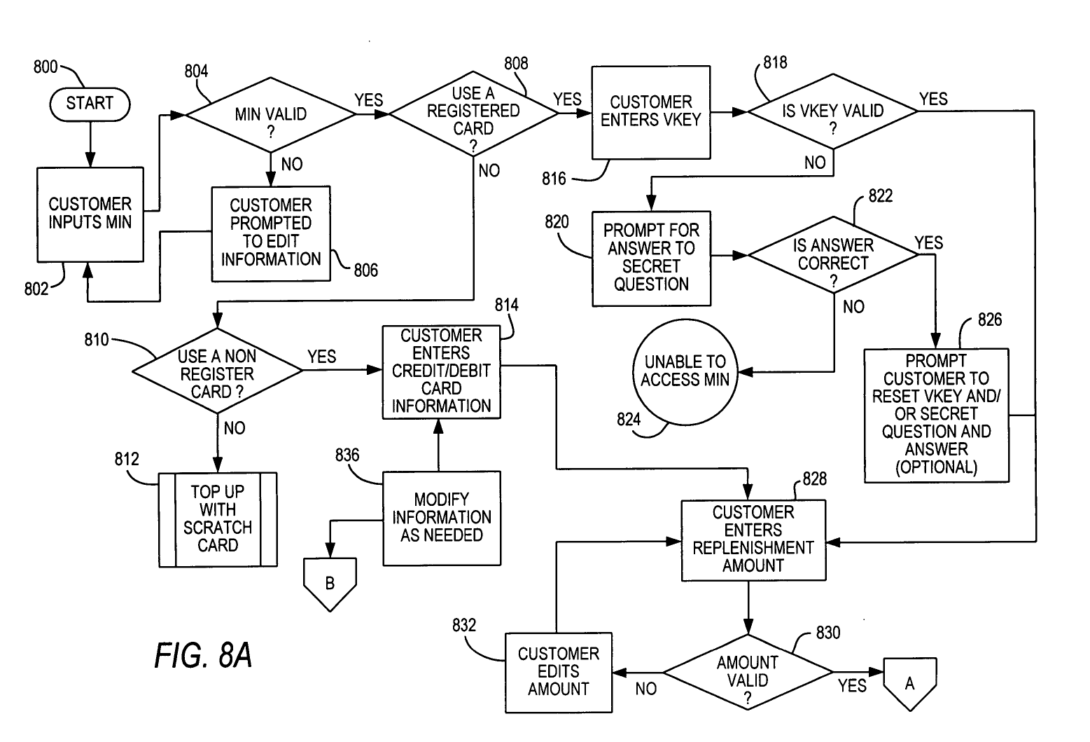

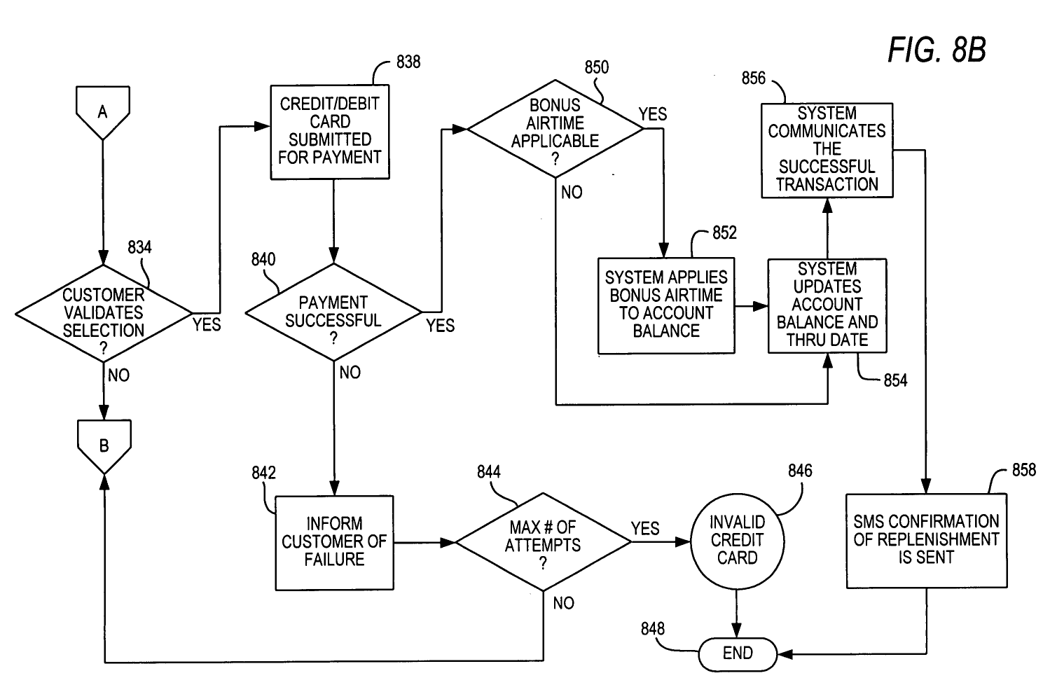

FIGS. 8A and 8B are a flow chart of a web-based Internet transaction for replenishment of an account using a credit/debit card in accordance with an embodiment of the present invention. The customer accesses a web page, e.g., a home page or an account maintenance page provided to enable web-based replenishment of an account. The transaction starts at 802 when the customer inputs an account identifier, such as a MIN. The MIN is tested at 804.

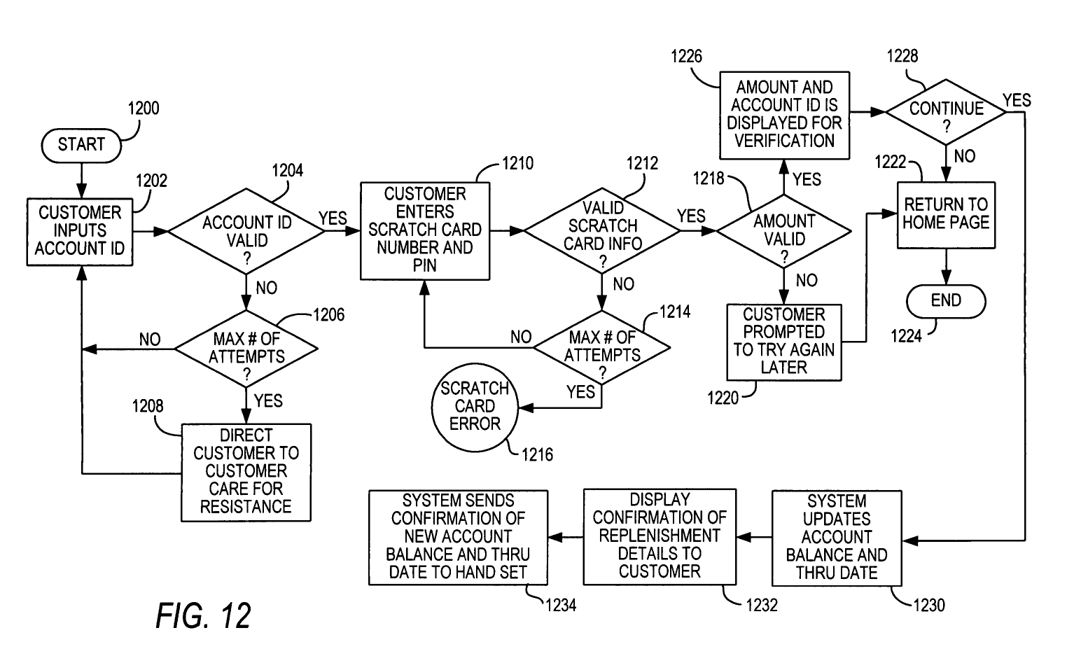

When a valid account identifier is entered, the customer may opt at 808 not to use a registered card. If the customer also chooses at 810 not to use an unregistered card, the customer may, for example, replenish with a scratch card at 812. This would entail starting a new transaction as detailed in FIG. 12. If the customer elects to use an unregistered card, the customer must enter credit/debit card information at 814. If, on the other hand, the customer uses a registered card, the system may display the last 4 digits of the card associated with the account identifier and prompt the customer to enter a validation key (vKey) at 816. The vKey is tested at 818. If the vKey is not valid, the customer is prompted at 820 for the answer to a secret question, which must be answered correctly at 822 to avoid an exception at 824. In that case, the customer is not to be granted access to the account associated with the account identifier. Following a correct answer to the secret question at. 822, the customer is prompted to reset the vKey and/or the secret question and answer at 826.

In any case, after the prompt to reset the vKey and/or secret question and answer, or after the system determines the vKey is valid, or after the customer enters credit/debit card information at 814 for an unregistered card, the customer enters a replenishment amount at 828. This amount entered is tested at 830 for compliance with these rules. If the amount is not valid, the customer edits the amount at 832 and reenters the replenishment amount at 828. When the amount is determined to be valid, the customer may view the MIN, card type, last four digits of the card, and the amount of replenishment. If the customer decides some part of the information is not as desired, the customer may opt at 834 to invalidate the selection, modify information as needed at 836, and reenter credit/debit card information at 814. If, on the other hand, the customer validates the selection at 834, the credit/debit card is submitted for authorization and payment at 838.

If the payment is not authorized, the customer is informed of the failure at 842. If the payment remains unauthorized after a number of attempts, an invalid credit card exception occurs at 846 as described previously. In either case, the transaction is terminated at 848. If payment is authorized, the credit/debit card account is charged the amount to be added to the customer's account and this amount less any service fee is added to the customer's account.

Next, the system tests at 850 if an airtime bonus is to be awarded, as described previously, and applies the award at 852, if applicable. Whether awarded or not, the system communicates the successful transaction to the customer at 856 along with transaction information. Then SMS confirmation of replenishment is sent to the appropriate handset at 858 and the transaction ends at 848.

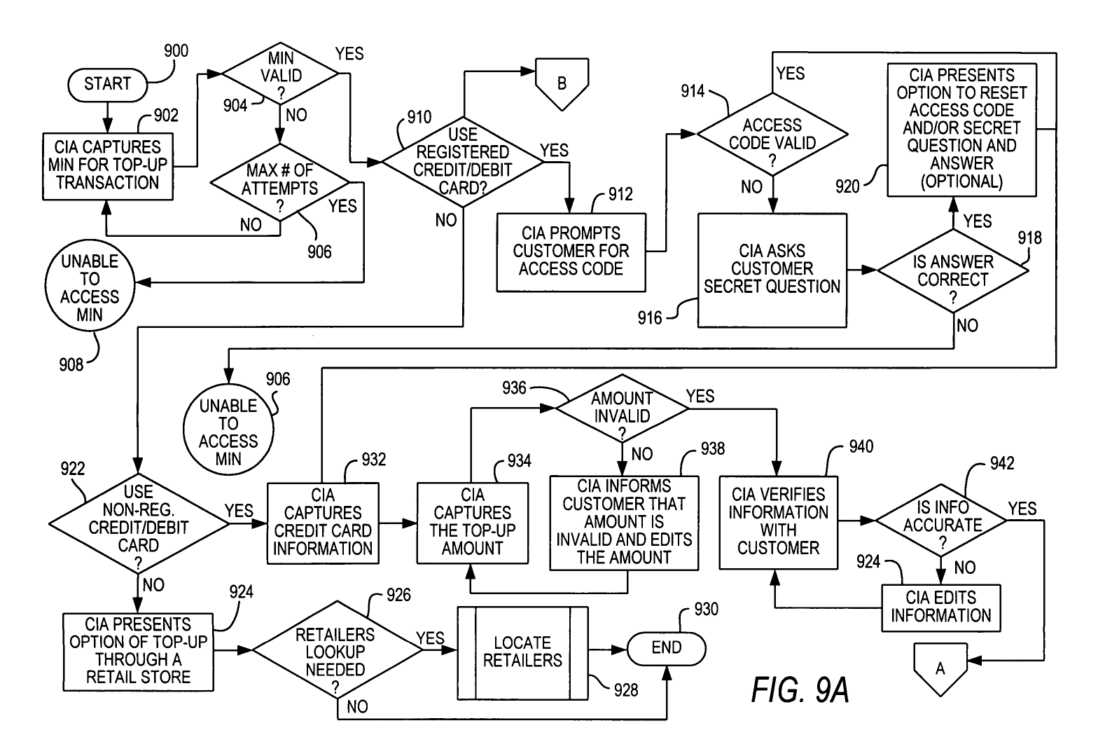

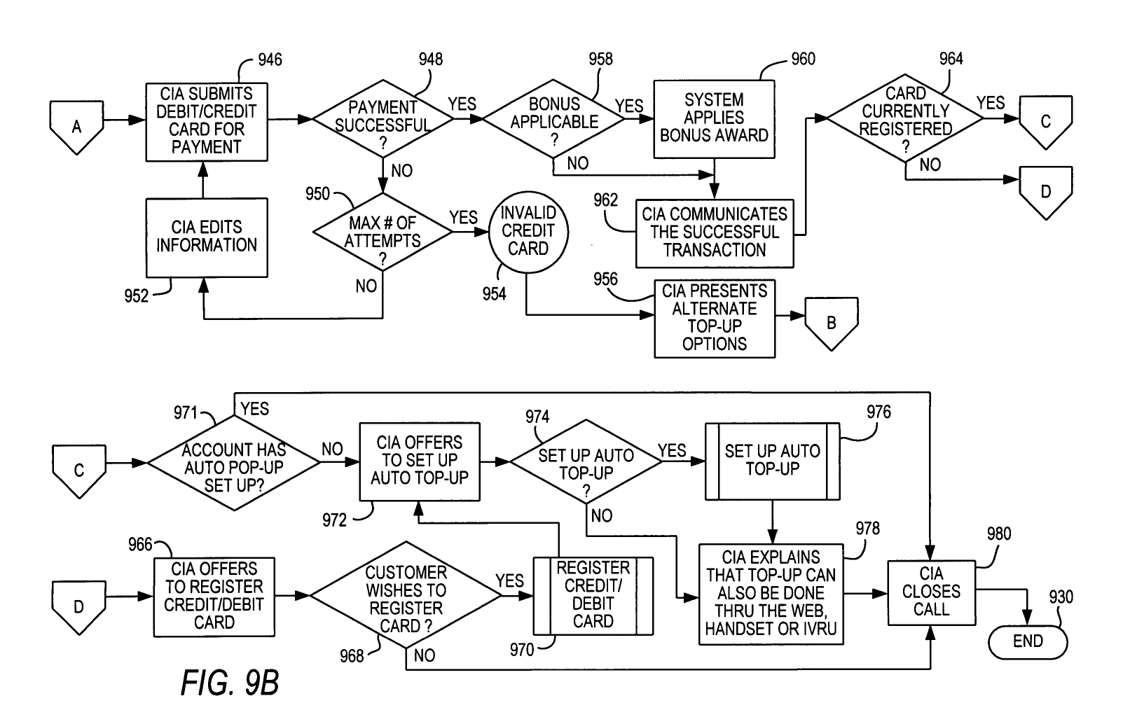

FIGS. 9A and 9B are a flow chart of a transaction specifically for replenishment of an account through a human agent using a credit/debit card in accordance with an embodiment of the present invention. The transaction starts when a human agent captures an account identifier, such as a MIN, for replenishment transaction at 902. The MIN could be captured systematically through the use of an IVR unit or the web prior to a customer engaging a human agent. This allows display of the customer's account information, such as the registered credit/debit card on the account to the human agent. The human agent could also capture the MIN by asking the customer for it. In any case, the human agent either captures the MIN or decides an unable to access MIN exception occurs at 908, as discussed previously. The MIN is tested at 904. The human agent has access to other account information that can be used to authenticate the customer who is unable to provide the MIN.

In any case, if the captured MIN is valid and the customer wishes to use a registered credit/debit card, the human agent prompts the customer for an access code for the credit card at 912. If the customer did not previously access his account, then the human agent will require the customer to access his account to perform replenishment on a registered credit/debit card. The access code is tested at 914. If the access code is invalid, then the human agent asks the customer at 916 a secret question associated with the MIN. If the answer is incorrect, then an unable to access MIN exception has occurred at 906. If the answer is correct, then the human agent may (optionally) present at 920 an option to reset the access code and/or the secret question and answer.

If the captured MIN is valid, but the customer does not wish to use a registered credit/debit card, then the customer may use a non-registered credit/debit card at 922. Since the customer is not required to use a credit/debit card, the human agent may (optionally) suggest at 924 replenishment through a PIN purchased at a retail store. If necessary, locations of scratch card retailers, for example, can be looked up at 928. In one embodiment, the lookup could be of recent replenishment locations, for example, the last five retailers from which the customer purchased scratch cards. Whether or not lookup is necessary, the transaction ends at 930 for customers who do not wish to replenish with a credit/debit card.

For those customers who wish to use a credit/debit card, the human agent captures credit/debit card information at 932. Then, the human agent captures the replenishment amount at 934 that the customer wishes to apply to the account associated with the MIN. This amount is subject at 936 to one or more tests as previously described. If the replenishment amount is not valid, the human agent informs the customer that the amount is invalid and edits the amount at 938. Note that, alternatively, the replenishment amount could be obtained prior to capturing credit/debit card information.

When the amount is determined to be valid, the human agent verifies the information with the customer at 940, editing the information at 944 if necessary. When the information is determined to be accurate at 942, the human agent submits the credit/debit card for authorization and payment at 946. If payment is not authorized, the human agent may determine, either after editing the information at 952, or without editing the information that an invalid credit card exception has occurred at 954, as described previously. When this exception occurs, the human agent has discretion to take appropriate action. Also, if the credit/debit card is registered but invalid, the human agent may require modification of the registered credit/debit card. After taking discretionary action, if appropriate, the human agent may present other payment options at 956 to the customer who may choose to use a registered credit/debit card or some other payment method at 910.

If payment is authorized, the credit/debit card account is charged the amount to be added to the customer's account and this amount less any service fee is added to the customer's account. When payment is successful, the system may apply at 960 an airtime bonus award as previously described. In any case, the human agent communicates the successful transaction to the customer at 962. After successful payment with a currently unregistered credit/debit card, the human agent may offer to register the credit/debit card at 966. If the customer wishes to register the credit/debit card, then the human agent registers the credit/debit card at 970. Otherwise, the human agent closes the call at 980 and the transaction ends at 930.

The system can provide for automatic replenishment, or “auto top-up,” of an account by a fixed amount on a periodic basis. If the account already has automatic replenishment set up for payment from the registered credit/debit card used in the current transaction, then the human agent closes the call at 980 and the transaction ends at 930. Otherwise, after successful payment with a registered credit/debit card or after registration of a credit/debit card, the human agent offers to set up automatic replenishment at 972. If the customer wishes to set up automatic replenishment, then automatic replenishment is set up at 976. In either case, the human agent may explain at 978 that replenishment can also be done thru the web, handset, or IVR unit and closes the call at 980, ending the transaction at 930.

The above access methods may also be used to replenish accounts by direct payment from bank accounts. In these cases appropriate account identification information is used instead of credit card or debit card information.

These access methods may also be used with PINs purchased from retailers using hot cards, POSA cards, or electronic PINs. Details of such purchased PIN access methods are set forth in FIGS. 10-13 below.

FIG. 10 is a flow chart of a transaction for replenishment of an account using a purchased PIN and handset in accordance with an embodiment of the present invention. The transaction starts when the customer selects “top-up using scratch card” from the handset menu 652 (FIG. 6) at 1002 and enters a PIN at 1004. The PIN is tested at 1006. If the PIN is not valid, the customer may reenter the PIN at 1004 a pre-determined maximum number of times. If the PIN is still not valid after a maximum number of attempts, an invalid PIN exception occurs at 1010. An invalid PIN exception may result in a message that the transaction is denied and provide the customer the option of contacting customer care. Following the invalid PIN exception, the transaction ends.

If the system determines that the PIN is valid, the system then determines at 1012 if the value associated with that PIN is acceptable with tests, such as the tests discussed. previously, or if an invalid amount exception occurs at 1014.

When an amount is valid, the amount and account identifier are displayed to the customer for verification at 1016. If the account displayed is not the desired account, the customer may enter another account identifier at 1020 and continue doing so until a desired account is entered at 1022. When the account is approved at 1018, the system updates the account balance and thru date at 1024 and sends an SMS replenishment alert to the appropriate handset at 1026. The customer selects the ‘OK’ menu item at 1028 and is routed to the previous screen at 1030. The transaction ends at 1032.

FIG. 6E depicts illustrative display screens used in implementing the method of FIG. 10. If, at top-up menu screen 652, top-up using scratch card is selected, scratch card PIN screen 674 is presented for entry of a PIN. If the PIN is invalid, the top-up menu screen 676 is presented to allow reentry of a PIN. If the PIN is not accepted for a predetermined number of times, top-up screen 678 is presented and either customer care may be contacted, if desired. Following entry of a scratch card PIN, top-up confirmation screen 680 displays the replenishment amount and the account to which the amount will be applied. The account may be changed by selecting ‘CHANGENUM’, causing top-up menu 682 to be presented, and identifying a different account. If the number identifying the different account is invalid, top-up menu 684 is displayed and the previous top-up confirmation screen 680 is displayed with the (unmodified) account to which the amount will be applied. When the account and amount are confirmed, either the top-up screen 686 (if the replenishment is invalid) or the top-up menu screen 688 (if the replenishment is valid) are presented. If the replenishment is invalid, one option is to contact customer care.

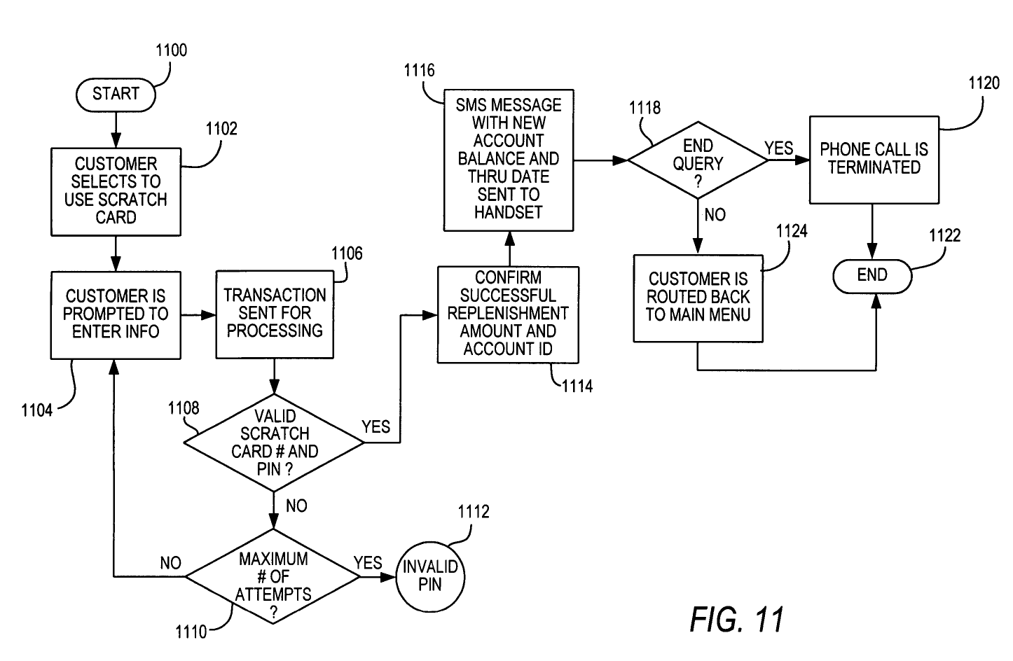

FIG. 11 is a flow chart of an interactive voice recognition (IVR) transaction for replenishment of an account using a scratch card in accordance with an embodiment of the present invention. The transaction starts when the customer elects to use a scratch card at 1102. The customer then phones the IVR unit and is prompted at 1104 to enter information, such as the scratch card number or the PIN associated with the scratch card, and the transaction is sent for processing at 1106. The scratch card number and PIN are tested at 1108. If the scratch card number and PIN are not valid, the customer may reenter information at 1104 until a maximum number of attempts are made, whereupon an invalid PIN exception issues at 1112. An invalid PIN exception may occur if the scratch card was not activated at the point-of-sale (POS). In this case, the customer may be routed to a customer care representative who refers the customer back to the retailer. An invalid PIN exception may also occur if the customer enters the scratch card number or PIN incorrectly. The customer is prompted to re-enter the information up to the maximum number of times, e.g., three consecutive times. If the scratch card number or PIN are entered incorrectly each time, the customer is preferably routed to customer care.

When the scratch card number and PIN are valid, the system updates the account balance and the successful replenishment amount and account ID are confirmed at 1114. The status of the scratch card is preferably set to ‘loaded’ in the PIN database. At 1116, the system sends an SMS message with the new account balance and thru date to the appropriate handset. If the customer wishes to end the query, the phone call is terminated at 1120 and the transaction ends at 1122. If the customer does not wish to end the query, the customer is routed back to the main menu at 1124 and the transaction ends at 1122.

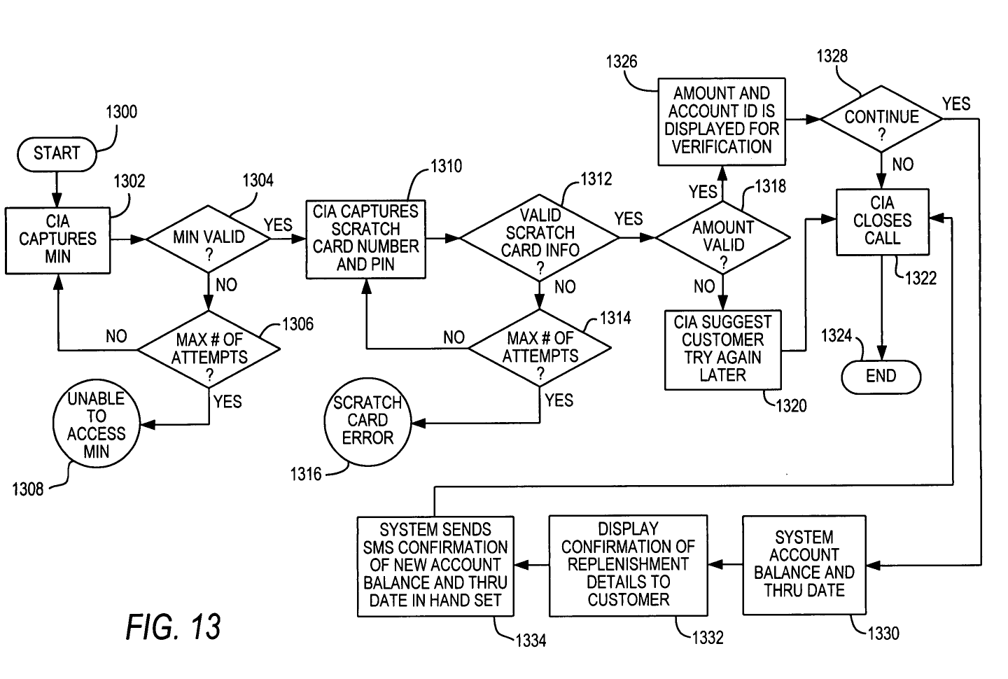

FIG. 12 is a flow chart of a web-based Internet transaction for replenishment of an account using a scratch card in accordance with an embodiment of the present invention. A customer accesses a web page, e.g., a home page or an account maintenance page, provided to enable web-based replenishment of an account. The customer inputs an account ID at 1202, for example, a MIN. The MIN is tested at 1204. If the account 1D is not valid and the customer has not yet made a maximum number of attempts, the customer may reenter the account ID at 1202. An invalid account ID is, for example, one that does not correspond to any account or one that corresponds to an account with an inappropriate status. The system may allow alternative action if the account ID is valid, but the account status is, for example, not one that allows replenishment. Such alternative action may include steps to activate accounts with, for example, a status of expired or voluntary disconnect before continuing with a replenishment transaction. If the customer has made a maximum number of attempts, the customer may be directed at 1208 to customer care for assistance. Then, the customer may either reenter the account ID at 1202, or be directed to another transaction process, such as the transaction illustrated in FIG. 13 for replenishment of an account with a scratch card through a human agent. Alternatively, the customer may simply ignore the offer of customer care and reenter the account ID at 1202.

When the customer enters a valid account ID, the customer then enters a scratch card number and PIN at 1210. In an alternative embodiment, the customer need only enter a single value, such as the PIN. The customer will have a maximum number of attempts, e.g., three times, to enter the correct scratch card PIN. Real-time validation of the PIN against the PIN database should be done to establish that the PIN is active and valid and update the PIN association in the database. If the system determines at 1212 that the scratch card information is invalid, and the customer has not made a maximum number of attempts, then the customer may reenter a scratch card number and PIN. A scratch card error may occur at 1216, for example, when the PIN is not active in the database or is associated to another account. If the customer has made a maximum n umber of attempts (or if the PIN is already used, in which case only one attempt is allowed), then a scratch card error 1216 has occurred.

When the system receives valid scratch card info from the customer, a balance check may be performed at 1218 to verify the amount will not exceed the daily transaction limit or cause the account to exceed the maximum allowed amount. If the amount is not valid, the customer is prompted at 1220 to try again later, is returned to the home page at 1222, and the transaction ends at 1224. If, on the other hand, the amount is valid, the amount and account ID are displayed for verification at 1226. The verification is to ensure the replenishment is applied to the correct account and the amount being applied to the account is verified by the customer. The customer may proceed with the transaction based on this information or choose at 1228 not to continue (i.e., to cancel the transaction), in which case the balance is not transferred from the card to the account, the customer is returned to the home page at 1222, and the transaction ends at 1224. If the customer continues, the system updates the account balance and thru date at 1230, displays confirmation of replenishment details to the customer at 1232, and sends to the appropriate handset an SMS confirmation at 1234 that may include, for example, the replenishment amount, the new account balance and the thru date. The system may test for bonuses to be awarded as described in conjunction with other access methods and the system reports the new account balance and thru date to the customer.

FIG. 13 is a flow chart of a transaction for replenishment of an account through a human agent using a scratch card in accordance with an embodiment of the present invention. The transaction starts when the human agent captures the MIN for an account at 1302. The MIN is tested at 1304. If the MIN is not valid, the human agent will continue to attempt to capture the MIN a maximum number of times. If the human agent is unable to capture the MIN after a maximum number of attempts, an unable to access MIN exception occurs at 1308.

When the human agent captures a valid MIN, the human agent then captures, for example, a scratch card number and PIN at 1310. The scratch card number and PIN are then tested at 1312. If the scratch card number or PIN is not valid, the human agent will continue to attempt to capture the scratch card number and PIN a maximum number of times. If the human agent is unable to capture the scratch card number and PIN after a maximum number of attempts, a scratch card error exception occurs at 1316.

When the human agent captures a valid scratch card number and PIN, the system determines at 1318 if the amount is acceptable. If the amount is not acceptable because, for example, the balance of the scratch card when applied to the balance associated with the MIN would result in the customer exceeding a maximum daily amount, the human agent suggests at 1320 that the customer try again later, closes the call at 1322, and the transaction ends at 1324. If the amount is valid, the amount and an account identifier are displayed for verification at 1326. At 1328, the customer may opt not to continue, in which case the human agent closes the call at 1322 and the transaction ends at 1324. If, instead, the customer wishes to continue 1328, the system updates the account balance and thin date 1330 for the account associated with the MIN. The human agent provides confirmation of replenishment details to the customer 1332 and sends SMS confirmation of the new account balance and thru date to the appropriate handset 1334. The human agent then closes the call 1322 and the transaction ends 1324.

While the present invention has been described with reference to a few specific embodiments, the description is illustrative of the invention and is not to be construed as limiting the invention. Various modifications may occur to those skilled in the art without departing from the true spirit and scope of the invention as defined by the appended claims.

We claim:

1. A method for obtaining an account balance of a wireless communication account, said wireless communication account associated with an account identifier, comprising:
associating a handset identifier with said wireless communication account;
transmitting a first message to an account maintenance system in response to a user selection of a predetermined handset key, said first message comprising at least said handset identifier and said account identifier; and
a handset associated with the handset identifier obtaining said account balance by receiving a second message, the second message providing an account balance for the wireless communication account associated with said account identifier.

2. The method of claim 1, wherein said transmitting a first message comprises:
enabling a soft key from a plurality of handset keys for replenishment of an account;
associating said account identifier with said soft key;
associating a null amount with said soft key; and
said transmitting of said first message being in response to a user selection of said soft key, said first message comprising a null amount, said account identifier, and said handset identifier.

3. The method of claim 2, wherein said first message further comprises payment account data.

4. The method of claim 1, wherein said second message is an SMS message.

5. The method of claim 1, wherein the predetermined handset key is a directional key.

6. The method of claim 1, wherein the wireless communication account is a prepaid telephone account.
